(19) United States
(12) Patent Application Publication
(10) Pub. No.: US 2024/0199851 A1
(43) Pub. Date: Jun. 20, 2024

(54) Improved Polymer Composition

(71) Applicant: DuPont Polymers, Inc., Wilmington, DE (US)

(72) Inventor: Eleni Karayianni, Meyrin (CH)

(21) Appl. No.: 18/556,374

(22) PCT Filed: May 6, 2022
(86) PCT No.: PCT/US2022/072172

§ 371 Date: Oct. 20, 2023

Related U.S. Application Data
(60) Provisional application No. 63/185,440, filed on May 7, 2021.

(51) Int. Cl. C08K 5/5313; C08G 69/40; C08J 3/20; C08K 3/32; C08K 5/3492; G02B 6/44; H01B 7/295

(52) U.S. Cl. CPC C08K 5/5313; C08G 69/40; C08J 3/201; G02B 6/443; H01B 7/295; C08J 2367/02; C08K 3/32; C08K 5/34928; C08K 2201/014

(57) ABSTRACT

The invention provides polymer compositions that are resistant to burning and which show reduced smoke production when exposed to heat or flame.

### FIELD OF THE INVENTION

The present invention relates to the field of polymer formulations, in particular flame-retardant polyesters, in particular copolyesters (e.g. copolyetheresters, copolyesteresters), polyamides, polyamide elastomers, thermoplastic polyolefinic elastomers, styrenic elastomers, thermoplastic polyurethanes and thermoplastic vulcanisates.

### BACKGROUND OF THE INVENTION

Copolyetheresters are a group of elastomeric polyesters having hard segments comprising polyester blocks and soft segments comprising long-chain polyether diols. They are widely used in applications in which resilience and elasticity are required.

A typical copolyetherester is made by reacting one or more diacid moieties with a short-chain diol and a long-chain polyether diol.

Copolyetheresters show excellent elasticity, maintenance of mechanical properties at low temperature and good fatigue performance.

There is an ongoing need for non-halogen-containing fire resistant (“NHFR”) copolyetheresters. Dialkyl phosphinate salts are well-known, non-halogenated flame retardant molecules. U.S. Pat. No. 7,420,007 [Clariant Produkte (Deutschland) GmbH] describes the use of dialkylphosphinic salts of the formula (I):

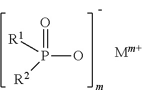

where R¹, R² are identical or different and are C₁-C₆-alkyl linear or branched,
M is Mg, Ca, Al, Sb, Sn, Ge, Ti, Fe, Zr, Zn, Ce, Bi, Sr, Mn, Li, Na, K and/or is a protonated nitrogen base; and
m is from 1 to 4;
as flame-retardants in many different polymers, including polyetheresters.

US2013/0190432 describes the use of aluminium diethyl phosphinate together with the aluminium salt of phosphorous acid as flame-retardant combination in nylon-6,6, nylon-6T/6,6, nylon-4,6, copolyetheresters and PBT.

U.S. Pat. No. 7,439,288 describes titanium diethyl phosphinates that are said to be useful as flame-retardants in high-impact polystyrene, polyphenylene ethers, polyamides, polyesters, polycarbonates, or blends or poly blends of the type represented by ABS (acrylonitrile-butadiene-styrene), or PC/ABS (polycarbonate/acrylonitrile-butadiene styrene), or PPE/HIPS (polyphenylene ether/HI polystyrene).

While the use of flame retardants in polymer resins can significantly reduce flammability, it can unfortunately result in high smoke production upon exposure to heat or flame. This is of concern since smoke can be a significant contributor to damage and mortality in fires.

There is a need for resin and flame-retardant combinations that show not only reduced flammability but also reduced smoke production on exposure to heat and/or flames.

### SUMMARY OF THE INVENTION

In a first aspect, the invention provides a flame-retardant polymer composition comprising:
(1) at least one polymer selected from polyesters, (e.g. copolyetheresters, copolyesteresters), polyamides, polyamide elastomers, thermoplastic polyolefinic elastomers, styrenic elastomers, thermoplastic polyurethanes and thermoplastic vulcanisates;
(2) aluminium diethylphosphinate; and
(3) titanium diethylphosphinate salt.

In a second aspect, the invention provides a flame-retardant polymer composition comprising:
(1) at least one polymer selected from polyesters, (e.g. copolyetheresters, copolyesteresters), polyamides, polyamide elastomers, thermoplastic polyolefinic elastomers, styrenic elastomers, thermoplastic polyurethanes and thermoplastic vulcanisates;
(2) aluminium diethylphosphinate; and
(3) titanium diethylphosphinate salt;
   wherein if the d₅₀ of the titanium diethylphosphinate (volume %, measured using laser diffraction technology with a Malvern Mastersizer 2000 particle size analyser instrument, in acetone) is greater than 35 microns, the concentration of the aluminium diethylphosphinate is less than or equal to 15 wt %, based on the total weight of the composition.

In a third aspect, the invention provides a flame-retardant copolyetherester composition comprising:
(1) at least one copolyetherester;
(2) aluminium diethylphosphinate; and
(3) titanium diethylphosphinate salt;
   wherein if the d₅₀ of the titanium diethylphosphinate salt (volume %, measured using laser diffraction technology with a Malvern Mastersizer 2000 particle size analyser instrument, in acetone) is greater than 35 microns, the concentration of the aluminium diethylphosphinate is less than or equal to 15 wt %, based on the total weight of the composition.

In a fourth aspect, the invention provides a shaped article made from a flame-retardant polymer composition comprising:
(1) at least one polymer selected from polyesters, (e.g. copolyetheresters, copolyesteresters), polyamides, polyamide elastomers, thermoplastic polyolefinic elastomers, styrenic elastomers, thermoplastic polyurethanes and thermoplastic vulcanisates;
(2) aluminium diethylphosphinate; and
(3) titanium diethylphosphinate salt;
   wherein if the d₅₀ of the titanium diethylphosphinate salt (volume %, measured using laser diffraction technology with a Malvern Mastersizer 2000 particle size analyser instrument, in acetone) is greater than 35 microns, the concentration of the aluminium diethylphosphinate is less than or equal to 15 wt %, based on the total weight of the composition.

In a fifth aspect, the invention provides a cable comprising a light or electrical conducting core and a sheath made from a flame-retardant polymer composition comprising:
(1) at least one polymer selected from polyester (e.g. copolyetheresters, copolyesteresters), polyamide, polyamide elastomer, thermoplastic polyolefinic elastomer, styrenic elastomer, thermoplastic polyurethane, thermoplastic vulcanisate and mixtures of these;
(2) aluminium diethylphosphinate; and
(3) titanium diethylphosphinate salt;
   wherein if the d₅₀ of the titanium diethylphosphinate salt (volume %, measured using laser diffraction technology with a Malvern Mastersizer 2000 particle size analyser instrument, in acetone) is greater than 35 microns, the concentration of the aluminium diethylphosphinate is less than or equal to 15 wt %, based on the total weight of the composition.

In a sixth aspect, the invention provides a method for making a composition of the invention, comprising the step of:
melt-mixing the ingredients listed in an extruder.

### DETAILED DESCRIPTION OF THE INVENTION

### Definitions and Abbreviations

PBT poly(butylene terephthalate)
PTMEG polytetramethylene ether glycol
Copolyetherester or TPC thermoplastic elastomer arising from the reaction of at least one diol, at least one diacid and at least one poly(alkylenoxide)diol
DEPAl aluminium diethyl phosphinate
DEPTi titanium salt of diethyl phosphinate, including species falling under the following formula:

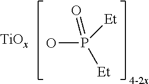

wherein x is from 0 to 1.9
DEPZn zinc diethylphosphinate
Phosphite as used herein is synonymous with aluminium and/or zinc “salts of phosphorous acid” or “salts of phosphonic acid”

The inventors have surprisingly found that when a polymer selected from polyesters, (e.g. copolyetheresters, copolyesteresters), polyamides, polyamide elastomers, thermoplastic polyolefinic elastomers, styrenic elastomers, thermoplastic polyurethanes and thermoplastic vulcanisates, in particular a copolyetherester is formulated with DEPAl and DEPTi, a composition having good flame-retardancy and reduced smoke production on exposure to heat and/or flame is obtained.

DEPAl and DEPTi are known to confer flame retardancy to polymer formulations. A well-recognised problem with flame-retardants additives in polymer resins is that while they improve the flame-retardancy of the polymer resin, they typically result in an increase in smoke production. The inventors have found that by using mixtures of DEPAl and DEPTi good flame-retardancy can be achieved, while maintaining an acceptable level of smoke production.

### Polymer Resin

The formulation of the invention comprises at least one polymer selected from polyesters, (e.g. copolyetheresters, copolyesteresters), polyamides, polyamide elastomers, thermoplastic polyolefinic elastomers, styrenic elastomers, thermoplastic polyurethanes and thermoplastic vulcanisates.

Preferred polymers are polyesters, particularly copolyetheresters, and polyamides. Copolyetheresters are particularly preferred.

Suitable polyesters include those selected from PET, PBT, copolyetheresters and mixtures of these.

Suitable polyamides include those selected from PA6, PA66, PA610, PA66/610, PA11, PA12, PA612, PA46, PA6T66, PA6/66, PA6/69, PA1010, PA1012, and mixtures of these. Particularly preferred are PA66 and PA6T66.

Copolyetheresters suitable for the compositions of the invention are polymers made by reacting a C₂-C₆ diol with an aromatic diacid moiety and a poly(alkyleneoxide)diol.

The poly(alkyleneoxide)diol is preferably selected from poly(ethyleneoxide)diol, poly(propyleneoxide)diol, poly(tetramethyleneoxide)diol (“PTMEG”), and mixtures of these. The poly(propyleneoxide)diol, poly(tetramethyleneoxide)diol may be straight-chain or branched. If they are branched at a carbon containing the terminal hydroxyl, they are preferably end-capped with ethylene glycol or poly(ethyleneoxide)diol. Particularly preferred, poly(propyleneoxide)diol and poly(tetramethyleneoxide)diol (“PTMEG”), and mixtures of these, with PTMEG being more particularly preferred.

The C₂-C₆ diol is preferably selected from ethylene glycol, propylene glycol, butylene glycol, and mixtures of these, with butylene glycol being more particularly preferred.

The aromatic diacid is preferably selected from terephthalate, iso-terephthalate, and mixtures of these, including their free acids, salts, and esters, with terephthalate being particularly preferred.

Particularly preferred copolyetheresters are selected from:
1. Copolyetheresters made from butylene diol, terephthalate and PTMEG;
2. Copolyetheresters made from butylene diol, terephthalate and poly(propyleneoxide)diol;
3. Copolyetheresters made from propylene diol, terephthalate and PTMEG; and
4. Copolyetheresters made from propylene diol, terephthalate and poly(propyleneoxide)diol.

Particularly preferred is a copolyetherester made from butylene diol, terephthalate and PTMEG.

The softness of copolyetheresters is affected by the chain-length (i.e. molecular weight) of the poly(alkyleneoxide)diol and by the relative amount of poly(alkyleneoxide)diol that is used to make the polymer.

In a preferred embodiment, the poly(alkyleneoxide)diol has a molecular weight of at or about 2000 g/mol.

In another preferred embodiment, the poly(alkyleneoxide)diol constitutes from 40 wt % to 80 wt % of the copolyetherester based on the total weight of the copolyetherester, more preferably 50 to 75 wt %, particularly preferably 72.5 wt %.

In a particularly preferred embodiment, the copolyetherester comprises a poly(alkyleneoxide)diol having a molecular weight of at or about 2000 g/mol at 40 wt % to 80 wt % of the copolyetherester based on the total weight of the copolyetherester, more preferably 50 to 75 wt %, particularly preferably 72.5 wt %.

A particularly preferred copolyetherester comprises at or about 72.5 weight percent of polytetramethylene oxide, preferably having an average molecular weight of about 2000 g/mol, as polyether block segments, the weight percentage being based on the total weight of the copolyetherester elastomer, the short chain ester units of the copolyetherester being polybutylene terephthalate segments.

### Phosphinates

In addition to at least one polyester (e.g. copolyetheresters, copolyesteresters), polyamide, polyamide elastomer, thermoplastic polyolefinic elastomer, styrenic elastomer, thermoplastic polyurethane and thermoplastic vulcanisate, the composition of the invention comprises aluminium diethyl phosphinate (“DEPAl”) and titanium diethyl phosphinate (“DEPTi”).

The total phosphinate concentration in the composition is preferably 5 to 50 wt %, more preferably 10 to 40 wt %, particularly preferably 10 to 25 wt %, based on the total weight of the copolyetherester composition.

Loadings of total phosphinate greater than 40 wt % may result in compositions having poor mechanical properties. For some applications the mechanical properties at such high loadings may be adequate, however, in general it is preferred that the total phosphinate concentration not exceed 40 wt %.

In a preferred embodiment, the DEPAl has a D₉₅ (volume %, measured using laser diffraction technology with a Malvern Mastersizer 2000 particle size analyser instrument, in acetone) of ≤10 microns, more preferably ≤8 microns.

DEPTi includes Titanium salts of diethylphosphinate of the following formula:

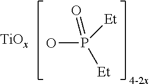

where x is a number from 0 to 1.9.

In a preferred embodiment, x is 1-1.05, meaning the ratio of Ti to diethylphosphinate is from 1.9 to 2.

Also in a preferred embodiment, the DEPTi has a D₅₀ (volume %, measured using laser diffraction technology with a Malvern Mastersizer 2000 particle size analyser instrument, in acetone) of ≤35 microns, more preferably ≤25 microns.

In another preferred embodiment, the DEPAl has a D₉₅ (volume %, measured using laser diffraction technology with a Malvern Mastersizer 2000 particle size analyser instrument, in acetone) of ≤10 microns and the DEPTi has a D₅₀ (volume %, measured using laser diffraction technology with a Malvern Mastersizer 2000 particle size analyser instrument, in acetone) of ≤35 microns.

When the D₅₀ of the titanium diethylphosphinate salt (volume %, measured using laser diffraction technology with a Malvern Mastersizer 2000 particle size analyser instrument, in acetone) is greater than 35 microns, the concentration of the aluminium diethylphosphinate is less than or equal to 15 wt %, based on the total weight of the composition.

The concentration of the DEPAl in the composition is preferably from 5 to 25 wt %, more preferably from 5 to 15 wt %, based on the total weight of the composition.

The concentration of the DEPTi in the composition is preferably from 1 to 15 wt %, more preferably from 5 to 12 wt %, based on the total weight of the composition.

### Phosphites

The compositions of the invention may additionally comprise an aluminium salt of phosphorous acid, a zinc salt of phosphorous acid or both.

Phosphorous acid has tautomeric forms as shown below:

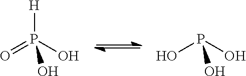

Aluminium salts of phosphorous acid are also referred to as aluminium phosphites.

Preferred aluminium phosphites are those having the CAS numbers [15099 32-8], [119103-85-4], [220689-59-8], [CAS 56287-23-1], [156024-71-4], [71449-76-8] and [15099-32-8]. Particularly preferred are aluminium phosphites of the type Al₂(HPO₃)₃*0.1-30 Al₂O₃*0-50 H₂O, more preferably of the type Al₂(HPO₃)₃*0.2-20 Al₂O₃*0-50 H₂O, most preferably of the type Al₂(HPO₃)₃*1-3 Al₂O₃*0-50 H₂O.

Particularly preferred are mixtures of aluminium phosphite and aluminium hydroxide having the composition of 5-95% by weight of Al₂(HPO₃)₃*nH₂O and 95-5% by weight of Al(OH)₃, more preferably 10-90% by weight of Al₂(HPO₃)*nH₂O and 90-10% by weight of Al(OH)₃, most preferably 35-65% by weight of Al₂(HPO₃)₃*nH₂O and 65-35% by weight of Al(OH)₃ and in each case n=0 to 4.

Preferred are aluminium phosphites having CAS numbers [15099-32-8], [119103-85-4], [220689-59-8], [56287-23-1], [156024 71 4], [71449-76-8] and [15099-32-8]. Particularly preferred is the aluminium phosphite having the CAS number [CAS 56287-23-1].

Particularly preferred is aluminium phosphite of the formula:

[HP(═O)O₂]²⁻₃Al³⁺₂

Also preferred is aluminium phosphite [Al(H₂PO₃)₃], secondary aluminium phosphite [Al₂(HPO₃)₃], basic aluminium phosphite [Al(OH)(H₂PO₃)₂·2H₂O], aluminium phosphite tetrahydrate [Al₂(HPO₃)₃·4H₂O], aluminium phosphonate, Al₇(HPO₃)₉(OH)₆(1,6-hexanediamine)_{1.5}·12H₂O, Al₂(HPO₃)₃·xAl₂O₃nH₂O with x=2.27-1 and/or Al₄H₆P₁₆O₁₈ as well as aluminium phosphites of the formulae (IV), (V) and/or (VI):

Al₂(HPO₃)₃x(H₂O)_{q} (IV)

in which q is from 0 to 4;

Al_{2,00}M_{z}(HPO₃)_{y}(OH)ᵥx(H₂O)_{w} (V)

in which M is an alkali metal cation, z is from 0.01 to 1.5, y is from 2.63 to 3.5, v is from 0 to 2 and w is 0 to 4;

Al_{2,00}(HPO₃)ᵤ(H₂PO₃)ₜx(H₂O)ₛ (VI)

in which u is from 2 to 2.99, t is from 2 to 0.01, s is from 0 to 4.

Also preferred are mixtures of aluminium phosphite of the formula (IV) with sparingly soluble aluminium salts with nitrogen-free counter ions, mixtures of aluminium phosphite of the formula (VI) with aluminium salts, mixtures of aluminium phosphite [Al(H₂PO₃)₃] with secondary aluminium phosphite [Al₂(HPO₃)₃], basic aluminium phosphite [Al(OH)(H₂PO₃)₂·2H₂O], aluminium phosphite tetrahydrate [Al₂(HPO₃)₃·4H₂O], aluminium phosphonate, Al₇(HPO₃)₉(OH)₆(1,6-hexanediamine)_{1.5}·12H₂O, Al₂(HPO₃)₃·xAl₂O₃·nH₂O with x=2.27-1 and/or Al₄H₆P₁₆O₁₈.

In a preferred embodiment, the phosphite(s) has a D₉₅ (volume %, measured using laser diffraction technology with a Malvern Mastersizer 2000 particle size analyser instrument, in acetone) of ≤10 microns.

In a preferred embodiment, the aluminium phosphite has a D₉₅ (volume %, measured using laser diffraction technology with a Malvern Mastersizer 2000 particle size analyser instrument, in acetone) of ≤10 microns.

Particularly preferred is aluminium phosphite [56287-23-1] having a D₉₅ (volume %, measured using laser diffraction technology with a Malvern Mastersizer 2000 particle size analyser instrument, in acetone) of ≤10 microns.

Zinc salts of phosphorous acid are referred to herein as zinc phosphites. Preferred are zinc phosphites having the CAS numbers [14332-59-3], [114332-59-3], [1431544-62-5], [14902-88-6], [52385 12 3] and [51728-08-6]. Particularly preferred is zinc phosphite having CAS number [CAS 14332-59-3], depicted below.

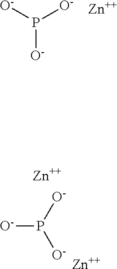

In a preferred embodiment, the zinc phosphite has a particle size of D₉₅ (volume %, measured using laser diffraction technology with a Malvern Mastersizer 2000 particle size analyser instrument, in acetone) of ≤10 microns. Alternatively, the zinc phosphite preferably has particle sizes from 0.1 to 100 micron and particularly preferably from 0.1 to 30 micron.

Preferred zinc phosphites include (ZnHPO₃), Zn(H₂PO₃)₂, Zn₂/3HPO₃, zinc phosphite hydrates, zinc pyrophosphite (ZnH₂P₂O₅), basic zinc phosphite of the formulae:

Zn₁₊ₓHPO₃(OH)₂ₓ

Zn₁₋ₓNa₂ₓHPO₄

where x=0-0.25.

Particularly preferred is zinc phosphite [14332-59-3] having a D₉₅ (volume %, measured using laser diffraction technology with a Malvern Mastersizer 2000 particle size analyser instrument, in acetone) of ≤10 microns.

Particularly preferred is zinc phosphite having the formula:

[HP(═O)O₂]²⁻Zn²⁺

In preferred compositions of the invention, aluminium phosphite [CAS 56287-23-1] and zinc phosphite [CAS 14332-59-3] are used.

In preferred compositions of the invention, a mixture of aluminium phosphite and zinc phosphite having following formulas is used:

[HP(═O)O₂]²⁻Zn²⁺

[HP(═O)O₂]²⁻₃Al³⁺₂

The total phosphite concentration is from 0.1 to 20 wt %, more preferably 2 to 20 wt %, more particularly preferably 2.5 to 10 wt % or less, based on the total weight of the copolyetherester composition. Although good smoke reduction is obtained with high phosphite loadings, above 10 wt % total phosphite, the flame-retardant characteristics of the composition may be compromised, making them unsuitable for certain applications. In a preferred embodiment, the total phosphite concentration is 2.5-10 wt %, based on the total weight of the composition.

In a preferred embodiment, the composition comprises 2.5 to 10 wt % aluminium phosphite, particularly aluminium phosphite [CAS 56287-23-1].

In another preferred embodiment, the composition comprises 2.5 to 10 wt % zinc phosphite, particularly zinc phosphite [CAS 14332-59-3].

Nitrogen- and/or Phosphorus-Containing Synergist

The compositions of the invention may additionally comprise at least one nitrogen-containing synergist and/or a phosphorus-containing flame retardant and/or a nitrogen-containing flame retardant. More preferably, the compositions additionally comprise at least one melamine derivative, selected from melamine salts with organic or inorganic acids and mixtures of these. More particularly preferably, the compositions of the invention additionally comprise at least one component selected from salts of melamine with boric acid, cyanuric acid, phosphoric acid and/or pyro/polyphosphoric acid, and mixtures of these. Particularly preferred is melamine pyrophosphate.

Also preferred are Melem, Melam, Melon, dimelaminepyrophosphate, melaminepolyphosphate, melempolyphosphate, melampolyphosphate, melonpolyphosphate and mixtures and salts of these.

The nitrogen- or phosphorus-containing synergist preferably has a D₅₀ of less than 20 microns, more preferably less than 18 microns.

Particularly preferred is a melamine pyrophosphate having a D₅₀ of less than microns, more preferably less than 18 microns.

When present, the nitrogen- and/or phosphorus-containing synergist is preferably present at from 2 to 10 wt %, more preferably 3 to 8 wt %, based on the total weight of the composition.

In a preferred embodiment, melamine pyrophosphate is used. In a more preferred embodiment, melamine pyrophosphate is used at from 2 to 10 wt %, more preferably 3 to 8 wt %, based on the total weigh of the composition.

### Additional Ingredients

Some particularly preferred compositions comprise additional optional additives, such as antioxidants, heat-stabilizers, UV-stabilizers, mineral fillers, glass fibres, colorants, lubricants, plasticizers, impact-modifiers, etc.

In particular, the compositions of the invention may comprise fillers and/or reinforcing agents such as calcium carbonate, silica, glass fibres, wollastonite, talc, kaolin, mica, barium sulphate, metal oxides and/or hydroxides, carbon black, zeolites and graphite.

The compositions of the invention may further comprise antioxidants, such as phosphitic and/or phenolic antioxidants.

Examples of antioxidants include alkylated monophenols, such as 2,6-di-tert-butyl-4-methylphenol; 1,2-alkylthiomethylphenols, for example, 2,4-di-octylthiomethyl-6-tert-butylphenol; hydroquinones and alkylated hydroquinones, such as 2,6-di-tert-butyl-4-methoxyphenol; tocopherols, for example, α- β- γ- and δ-tocopherols, and mixtures thereof (vitamin E); hydroxylated thiodiphenyl ethers, for example 2,2′-thio-bis-(6-tert-butyl-4-methylphenol), 2,2′-thio-bis-(4-octylphenol), 4,4′-thio-bis-(6-tert-butyl-3-methylphenol), 4,4′-thio-bis (6-tert-butyl-2-methylphenol), 4,4′-thio-bis (3,6-di-sec-amylphenol), 4,4′-bis (2,6-dimethyl-4-hydroxyphenyl)disulphide; alkylidene bisphenols, for example, 2,2′-methylenebis (6-tert-butyl-4-methylphenol; O-, N- and S-benzyl compounds, for example, 3,5,3′,5′-tetra-tert-butyl-4,4′-dihydroxydi-benzyl ether; hydroxybenzylated malonates, for example, dioctadecyl-2,2-bis-(3,5-di-tert-butyl-2-hydroxybenzyl)malonate; hydroxybenzyl aromatics, for example, 1,3,5-tris-(3,5-di-tert-buty)-4-hydroxybenzyl)-2,4,6-trimethylbenzol, 1,4-bis (3,5-di-tert-butyl-4-hydroxybenzyl)-2,3,5,6-tetramethylbenzene 2,4,6-tris-(3,5-di-tert-buryl-4-hydroxybenzyl)-phenol; triazine compounds, for example, 2,4-bis-octylmercapto-6 (3,5-di-tert-butyl-4-hydroxyanilino)-1,3,5-triazine; Benzyl phosphonates, for example, dimethyl 2,5-di-tert-butyl-4-hydroxybenzyl phosphonate; acylaminophenols, 4-hydroxylauric acid amide, 4-hydroxystearic acid anilide, N-(3,5-di-tert-butyl-4-hydroxyphenyl)-carbamic acid octyl ester; esters of β-(3,5-di-tert-butyl-4-hydroxyphenyl) propionic acid with monohydric or polyhydric alcohols; esters of β-(5-tert-butyl-4-hydroxy-3-methylphenyl) propionic acid with monohydric or polyhydric alcohols; esters of β-(3,5-dicyclohexyl-4-hydroxyphenyl)propionic acid with mono- or polyhydric alcohols; esters of 3,5-di-tert-butyl-4-hydroxyphenylacetic acid with monohydric or polyhydric alcohols; amides of β-(3,5-di-tert-butyl-4-hydroxyphenyl)propionic acid, such as N, N′-bis-(3,5-di-tert-butyl-4-hydroxyphenylpropionyl)-hexamethylenediamine, N,N′-bis-(3,5-di-tert-butyl-4-hydroxyphenylpropionyl)-trimethylenediamine, N,N′-bis (3,5-di-tert-butyl-4-hydroxyphenylpropionyl) hydrazine.

Some particular examples of antioxidants include tris(2,4-di-tert-butylphenyl)phosphite (Irgafos®168), N,N′-1,6-hexanediylbis[3,5-bis(1,1-dimethylethyl)-4-hydroxyphenylpropanamide] (Irganox®1098), mixtures of Irgafos®168 and Irganox®1098 (such mixtures are particularly suitable for polyamides, such as PA66), N,N′-1,6-hexanediylbis[3,5-bis(1,1-dimethylethyl)-4-hydroxyphenylpropanamide] (Ultranox®626), octadecyl 3-(3,5-di-tert-butyl-4-hydroxyphenyl)propionate (Irganox®1076), and mixtures of Ultranox®626 and Irganox®1076 (such mixtures are particularly suitable for polyesters, such as PBT).

The compositions of the invention may further comprise UV-absorbers and light-stabilizers, such as 2-(2′-hydroxy-5′-methylphenyl)benzotriazole; 2-hydroxybenzophenones, such as 4-hydroxy, 4-methoxy, 4-octoxy, 4-decyloxy-, 4-dodecyloxy-, 4-benzyloxy-, 4,2′, 4-trihydroxy-, 2′ hydroxy-4,4′-dimethoxy-derivatives; esters of optionally substituted benzoic acids, such as 4-tert-butyl-phenyl salicylate, phenyl salicylate, octylphenyl salicylate, dibenzoyl resorcinol, bis (4-tert-butylbenzoyl) resorcinol, benzoylresorcinol, 3,5-di-tert-butyl-4-hydroxybenzoic acid-2,4-di-tert-butylphenyl ester, 3,5-di-tert-butyl-4-hydroxybenzoic acid hexadecyl ester, 3,5-di-tert-butyl-4-hydroxybenzoic acid octadecyl ester, 3,5-di-tert-butyl-4-hydroxybenzoic acid-2-methyl-4, 6-di-tert-butylphenyl ester; acrylates, such as α-cyano-β,β-diphenylacrylic acid ethyl ester or -isooctyl ester, α-carbomethoxycinnamate, α-cyano-β-methyl-p-methoxycinnamate or butyl ester, α-carbomethoxy-p-methoxycinnamic acid methyl ester, N-(β-carbomethoxy-β-cyanovinyl)-2-methyl-indoline.

Suitable polyamide stabilizers are, for example, copper salts in combination with iodides and/or phosphorus compounds and salts of divalent manganese.

Suitable basic co-stabilizers are melamine, polyvinylpyrrolidone, dicyandiamide, triallyl cyanurate, urea derivatives, hydrazine derivatives, amines, polyamides, polyurethanes, alkali and alkaline earth salts of higher fatty acids, for example Ca stearate, Zn stearate, Mg behenate, Mg Stearate, Na ricinoleate, K palmitate, antimony catecholate or tin catecholate.

Suitable nucleating agents are, for example, 4-tert-butylbenzoic acid, adipic acid and diphenylacetic acid.

As further flame retardants, the compositions may include aryl phosphates, organic phosphonates, salts of hypophosphorous acid and red phosphorus.

Other additives include, for example, plasticizers, expandable graphite, emulsifiers, pigments, optical brighteners, flame retardants, antistatic agents, propellants.

### Examples of Preferred Embodiments

Some preferred compositions of the invention are listed below. Wt %'s are based on the total weight of the composition.
1. A preferred composition of the invention is a polymer composition comprising:
   (1) at least one polyester (e.g. copolyetheresters, copolyesteresters), polyamide, polyamide elastomer, thermoplastic polyolefinic elastomer, styrenic elastomer, thermoplastic polyurethane and thermoplastic vulcanisate;
   (2) DEPAl;
   (3) DEPTi;
   wherein the concentration of DEPAl (2) plus DEPTi (3) is between 8-30 wt %, based on the total weight of the composition.
2. A composition according to embodiment 1, comprising:
   (1) at least one copolyetherester;
   (2) DEPAl;
   (3) DEPTi;
   (4) an aluminium salt of phosphorous acid, a zinc salt of phosphorous acid or both;
   (5) a nitrogen-containing synergist.
3. A composition according to embodiment 1 or 2, comprising:
   (1) at least one copolyetherester;
   (2) DEPAl;
   (3) DEPTi;
   (4) a zinc salt of phosphorous acid;
   (5) a nitrogen-containing synergist.
4. A composition according to any one preceding embodiment, comprising:
   (1) at least one copolyetherester;
   (2) DEPAl;
   (3) DEPTi;
   (4) an aluminium salt of phosphorous acid, a zinc salt of phosphorous acid or both;
   (5) a nitrogen-containing synergist, which is melamine pyrophosphate.
5. A composition according to any one preceding embodiment, comprising:
   (1) at least one copolyetherester;
   (2) DEPAl;
   (3) DEPTi;
   (4) a zinc salt of phosphorous acid;
   (5) a nitrogen-containing synergist, which is melamine pyrophosphate.
6. A composition according to any one preceding embodiment, comprising:
   (1) at least one copolyetherester;
   (2) DEPAl;
   (3) DEPTi;
   (4) an aluminium salt of phosphorous acid, a zinc salt of phosphorous acid or both.
7. A composition according to any one preceding embodiment, wherein the DEPAl is present at 5 to 50 wt %, based on the total weight of the composition.
8. A composition according to any one preceding embodiment, wherein the DEPTi is present at 5 to 50 wt %, based on the total weight of the composition.
9. A composition according to any one preceding embodiment, wherein the DEPAl is present at 5 to 50 wt %, and the DEPTi is present at 5 to 50 wt %, based on the total weight of the composition.
10. A composition according to any one preceding embodiment, wherein the concentration of DEPAl is 5 to 25 wt %, based on the total weight of the composition.
11. A composition according to any one preceding embodiment, wherein the concentration of DEPTi is 1 to 15 wt %, based on the total weight of the composition.
12. A composition according to any one preceding embodiment, wherein the DEPAl has a D₉₅ (volume %, measured using laser diffraction technology with a Malvern Mastersizer 2000 particle size analyser instrument, in acetone) of ≤10 microns.
13. A composition according to any one preceding embodiment, wherein the DEPTi has a D₅₀ (volume %, measured using laser diffraction technology with a Malvern Mastersizer 2000 particle size analyser instrument, in acetone) of ≤35 microns.
14. A composition according to any one preceding embodiment, wherein the at least one copolyetherester is selected from polymers made by reacting a C₂-C₆ diol with an aromatic diacid moiety and a poly(alkyleneoxide)diol.
15. A composition according to any one preceding embodiment, which further comprises an aluminium salt of phosphorous acid, a zinc salt of phosphorous acid or both.
16. A composition according to any one preceding embodiment, further comprising aluminium phosphite having the CAS number [CAS 56287-23-1], zinc phosphite having CAS number [CAS 14332-59-3], or a mixture of these.
17. A composition according to any one preceding embodiment, wherein the aluminium phosphite has a D₉₅ (volume %, measured using laser diffraction technology with a Malvern Mastersizer 2000 particle size analyser instrument, in acetone) of ≤10 microns.
18. A composition according to any one preceding embodiment, wherein the zinc phosphite has a D₉₅ (volume %, measured using laser diffraction technology with a Malvern Mastersizer 2000 particle size analyser instrument, in acetone) of ≤10 microns.
19. A composition according to any one preceding embodiment, wherein the total phosphite concentration is from 0.1 to 20 wt %, based on the total weight of the composition.
20. A composition according to any one preceding embodiment, wherein the ratio of DEPAl/DEPTi is less than or equal to 1.
21. A composition according to any one preceding embodiment, wherein the ratio of DEPAl/DEPTi is from 0.5 to 1.
22. A composition according to any one preceding embodiment, which further comprises a nitrogen- and/or phosphorus-containing synergist.
23. A composition according to any one preceding embodiment, which further comprises the nitrogen-containing synergist melamine pyrophosphate.
24. A composition according to any one preceding embodiment, wherein the nitrogen-containing synergist is present at from 2 to 10 wt %, based on the total weight of the composition.
25. A composition according to any one preceding embodiment, wherein the nitrogen-containing synergist is present at from 3 to 8 wt %, based on the total weight of the composition.
26. A composition according to any one preceding embodiment, comprising:
   (1) at least one copolyetherester;
   (2) DEPAl;
   (3) DEPTi;
   (4) an aluminium salt of phosphorous acid, a zinc salt of phosphorous acid or both;
   (5) a nitrogen-containing synergist.
27. A composition according to embodiment 26, comprising:
   (1) at least one copolyetherester;
   (2) DEPAl;
   (3) DEPTi;
   (4) a zinc salt of phosphorous acid;
   (5) a nitrogen-containing synergist.
28. A composition according to embodiment 26 or 27, wherein the nitrogen-containing synergist is melamine pyrophosphate.
29. A composition according to embodiment 26, 27 or 28, wherein the DEPAl is present at 5 to 15 wt %, based on the total weight of the composition.
30. A composition according to any one of embodiments 26-29, wherein the DEPTi is present at 5 to 15 wt %, based on the total weight of the composition.
31. A composition according to any one of embodiments 26-30, wherein the zinc salt of phosphorus acid is zinc phosphite having CAS number [CAS 14332-59-3].
32. A composition according to any one of embodiments 26-31, wherein the nitrogen-containing synergist is present at 2 to 10 wt %, based on the total weight of the composition.
33. A composition according to any one of embodiments 26-32, wherein the DEPAl has a D₉₅ (volume %, measured using laser diffraction technology with a Malvern Mastersizer 2000 particle size analyser instrument, in acetone) of ≤10 microns.
34. A composition according to any one of embodiments 26-33, wherein the DEPTi has a D₅₀ (volume %, measured using laser diffraction technology with a Malvern Mastersizer 2000 particle size analyser instrument, in acetone) of ≤35 microns.
35. A composition according to any one of embodiments 26-34, wherein the zinc salt of phosphorous acid has a D₉₅ (volume %, measured using laser diffraction technology with a Malvern Mastersizer 2000 particle size analyser instrument, in acetone) of ≤10 microns.
36. A composition according to any one of embodiments 26-35, wherein the copolyetherester is a polymer made by reacting a C₂-C₆ diol with an aromatic diacid moiety and a poly(alkyleneoxide)diol.
37. A composition according to any one preceding embodiment, having an LOI of 30 or greater, more preferably 31 or greater, more particularly preferably 33 or greater when measured according to test method ISO 4589-1/-2.
38. A composition according to any one preceding embodiment, having a D_{s,max}/mass retained in g measured according to ISO 5659 test standard and using plaques having an area of 75 mm×75 mm and thickness of 2 mm, of not greater than 60, more preferably not greater than 46, more particularly not greater than 40.
39. A composition according to any one preceding embodiment, having an LOI of 30 or greater, more preferably 31 or greater, more particularly preferably 33 or greater when measured according to test method ISO 4589-1/-2; AND
   a D_{s,max}/mass retained in g measured according to ISO 5659 test standard and using plaques having an area of 75 mm×75 mm and thickness of 2 mm, of not greater than 60, more preferably not greater than 46, more particularly not greater than 40.
40. A composition according to any one preceding embodiment, wherein DEPTi includes Titanium salts of diethylphosphinate of the following formula:

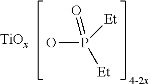

where x is a number from 0 to 1.9.
41. A composition according to embodiment 40, wherein x is 1-1.05, meaning the ratio of Ti to diethylphosphinate is from 1.9 to 2.
42. A composition of any one preceding embodiment, in the form of pellets.
43. A wire or cable comprising a light- or electricity-conducting core surrounded by at least one sheath made from the composition of any one preceding embodiment.
44. A flame-retardant polymer composition comprising:
   (1) at least one polymer selected from copolyesters (e.g. copolyetheresters, copolyesteresters), polyamides, polyamide elastomers, thermoplastic polyolefinic elastomers, styrenic elastomers, thermoplastic polyurethanes and thermoplastic vulcanisates;
   (2) a flame-retardant mixture which comprises 5-50 wt % aluminium diethylphosphinate and/or zinc diethylphosphinate, and 5-50 wt % titanium diethylphosphinate salt, based on the total weight of the flame-retardant mixture.
45. A composition according to embodiment 44, wherein the titanium diethylphosphinate salt has the following formula:

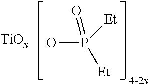

wherein x is from 0 to 1.9.
46. A composition according to embodiment 44 or 45, wherein the polymer is selected from polyesters, copolyetheresters, polyamides and mixtures of these.
47. A flame-retardant polymer composition comprising:
   (1) at least one polymer selected from polyesters;
   (2) aluminium diethylphosphinate; and
   (3) titanium diethylphosphinate salt.
48. A composition according to embodiment 47, wherein the polyester is selected from PET, PBT and mixtures of these.
49. A flame-retardant polymer composition comprising:
   (1) at least one polymer selected from polyamides;
   (2) aluminium diethylphosphinate; and
   (3) titanium diethylphosphinate salt.
50. A composition according to embodiment 49, wherein the polyamide is selected from PA66, PA6T66 and mixtures of these.
51. A composition according to any one of embodiments 47-50, which further comprises aluminium phosphite and/or zinc phosphite of the formulae:

[HP(═O)O₂]²⁻Zn²⁺ (II)

[HP(═O)O₂]²⁻₃Al³⁺₂ (III).
52. A composition according to any one of embodiments 47-51, which further comprises at least one nitrogen-containing synergist and/or a phosphorus-containing flame retardant and/or a nitrogen-containing flame retardant.
53. A composition according to embodiment 52, wherein the nitrogen-containing synergist/flame-retardant is selected from melamine cyanurate, melamine pyrophosphate, melamine polyphosphate, melem, and mixtures of these.

### Manufacture

The compositions of the invention may be made by incorporating the ingredients into the polymer at various steps. For example, the ingredients can be added at the beginning or end of the polycondensation reaction to build the polymer, or the ingredients may be melt-mixed with the polymer by melting the polymer, for example, in a twin-screw extruder, and mixing in the other ingredients.

When desired, the non-polymer ingredients may be formulated as a mixture, before incorporating into the polymer. Alternatively, the non-polymer ingredients may be added individually to the polymer(s).

The non-polymer ingredients may be formulated in concentrated form in a polymer by melt-mixing. Such a concentrated formulation is termed a “masterbatch”. The invention extends to such masterbatches, in which the non-polymer ingredients are dispersed in a polymer matrix at concentrations for 2-6 fold higher than the desired final concentration in the polymer that will be used to make articles (for example, wire and cable sheaths).

### Performance

The compositions of the invention show good flammability performance. Flammability can be assessed by methods known to one skilled in the art. One method is Limiting Oxygen Index (“LOI”) according to test method ISO 4589-1/-2. Preferably the compositions of the invention show an LOI of 30 or greater, more preferably 31 or greater, more particularly preferably 33 or greater when measured according to test method ISO 4589-1/-2.

The compositions of the invention achieve a good combination of good flammability performance and reduced smoke production.

Smoke density testing can be performed according to ISO 5659 test standard inside an NBS smoke chamber. Test specimens are prepared as plaques having an area of 75 mm×75 mm and thickness of 2 mm. The specimens are mounted horizontally within the chamber and exposed to a constant thermal irradiance on their upper surface of 25 kW/m² via a radiator cone and heat flux meter and in the presence of a pilot flame for a period of about 40 min. The smoke evolved over time is collected in the chamber, and the attenuation of a light beam passing through the smoke is measured with a photometric system including a 6.5 V incandescent lamp, a photomultiplier tube, and a high accuracy photodetector. The results are measured in terms of light transmission over time and reported in terms of specific optical density, Dₛ. Ds is inversely proportional to light transmission and is given for a specific path length equal to the thickness of the moulded specimen. Smoke production is measured as max specific optical density, D_{s,max}. Any dripping from the plaque test specimen occurring during the test is recorded. A normalised D_{s,max} over the mass retained during the experiment time can be calculated, and is reported as D_{s, max}/mass retained in g.

Low values of D_{s,max}/mass retained in g are desirable and indicative of material that will reduce visibility less in the event of fire, thus allowing rapid escape of people from confined spaces. Without any smoke light transmittance is 100% and Dₛ is 0.

The compositions of the invention preferably show a D_{s,max}/mass retained in g measured according to ISO 5659 test standard and using plaques having an area of 75 mm×75 mm and thickness of 2 mm, of not greater than 60, more preferably not greater than 46, more particularly not greater than 40.

In a more particularly preferred embodiment, the compositions of the invention have an LOI of 30 or greater, more preferably 31 or greater, more particularly preferably 33 or greater when measured according to test method ISO 4589-1/-2, and a D_{s,max}/mass retained in g measured according to ISO 5659 test standard and using plaques having an area of 75 mm×75 mm and thickness of 2 mm, of not greater than 60, more preferably not greater than 46, more particularly not greater than 40.

### Applications

The compositions of the invention are suitable for any application in flame-resistance and low-smoke performance is required. They may be provided to the consumer, for example, in the form of pellets. The pellets are used by melting them, for example in an extruder, and can then be formed using, for example, injection moulding, blow moulding, extrusion.

A particularly suitable application for the compositions is as coating or jacket for electrical or optical cables. A cable comprises an electrical or optical conducting core surrounded by a sheath made from a composition of the invention. The cable may additionally comprise other layers, such as reinforcing layers and insulating layers.

Such cables may be made, for example, by extruding the sheath made of the composition of the invention around the conductive core and/or around additional layers of the cable.

In a particularly preferred embodiment, the cable is a USB cable.

### Examples

The invention is further illustrated by certain embodiments in the examples below which provide greater detail for the compositions, uses and processes described herein.

### Materials

The following materials were used to prepare the flame retardant polymer compositions described herein and the compositions of the comparative examples.

Copolyetherester (TPC1 and TPC2): a copolyetherester elastomer comprising about 72.5 weight percent of polytetramethylene oxide having an average molecular weight of about 2000 g/mol as polyether block segments, the weight percentage being based on the total weight of the copolyetherester elastomer, the short chain ester units of the copolyetherester being polybutylene terephthalate segments. The copolyetherester elastomer contained up to 6 weight percent of heat stabilizers, antioxidants and metal deactivators. TPC1 had a melt mass flow rate of 11 g/10 min measured at 190° C., 2.16 kg. TPC2 had a melt mass flow rate of 5 g/10 min measured at 190° C., 2.16 kg.

PBT: poly(butylene terephthalate)

PA66: polyamide 6,6

Polyamide 6T/66: a polyamide made from the comonomers hexamethylene diamine, adipic acid and terephthalic acid

DEPAl: Aluminium diethylphosphinate having a D90 max (volume %, measured using laser diffraction technology with a Malvern Mastersizer 2000 particle size analyser instrument, in acetone) of 7.506 microns.

DEPTi: Titanium diethylphosphinate. 3 different lots were evaluated with particle size d50 of 20 μm, 31 μm and 41 μm (volume %, measured using laser diffraction technology with a Malvern Mastersizer 2000 particle size analyser instrument, in acetone).

DEPZn: Zinc diethyl phosphinate.

Al Phosphite: Phosphorous acid, Aluminium salt [CAS 56287-23-1].

Melamine pyrophosphate (MDP): melamine pyrophosphate having a D₅₀ of microns, as measured using laser diffraction technology with a Malvern Mastersizer 2000 particle size analyser instrument, in acetone.

Melamine cyanurate

Melamine polyphosphate (MPP)

Melem: 2,5,8-triamino-heptazine

Irganox® 1010: (Pentaerythritol tetrakis(3-(3,5-di-tert-butyl-4-hydroxyphenyl) propionate), a sterically hindered phenol antioxidant

Irganox® 1330: (3,3′,3′,5,5′,5′-hexa-tert-butyl-a,a′,a′-(mesitylene-2,4,6-triyl)tri-p-cresol), a sterically hindered phenol antioxidant

Irganox® 245: ethylene bis (oxyethylene) bis-(3-(5-tert-butyl-4-hydroxy-m-tolyl)-propionate), a sterically hindered phenol antioxidant

LICOWAX® E: ester of montanic acids with multifunctional alcohols, lubricant wax

### Formulations

The additive ingredients listed in Tables 1-6 were mixed with polymer pellets/granules in a twin-screw extruder at temperatures about 10-20° C. above the melting temperature of the polymer. The homogenized resin formulation was extruded, cooled and cut into pellets. The pellets were remelted as needed and formed into test pieces as described in the Test Methods.

### Test Methods

### Flame Retardance-LOI

Test specimens based on TPC1 thermoplastic elastomer were prepared from the compositions of the tables by melt-extruding narrow flat strips in a standard extruder having barrel temperatures set at about 170° C. to about 190° C. and cutting test specimen, in the shape of rectangular bars of dimension 125 mm long by 13 mm wide and having an average thickness of about 1.7±0.1 mm, from the thus-obtained flat strips. Test specimens based on TPC2 thermoplastic elastomer were prepared from the compositions of the tables by melt-extruding pellets in a standard extruder having barrel temperatures set at about 200° C. and injection-moulding test specimen in the shape of ISO 178 flex bars of dimension 80 mm long by 10 mm wide by 4 mm thick. Test specimens were conditioned for at least 72 hours at room temperature and 50% relative humidity before testing. According to this test, the specimen is clamped vertically at the centre of a glass chimney at room temperature in an atmosphere of a mixture of oxygen and nitrogen slowly fed into the glass column upwards, where the relative concentration of oxygen and nitrogen can be changed. The upper end of the test sample is ignited with a pilot flame and burns downward. The burning behaviour of the specimen is observed to compare the period for which burning continues. LOI is the minimum concentration of oxygen, expressed as a volume percentage, required to sustain the combustion of the sample indicated by a target burning time after ignition of less than 180 sec. High values of LOI are desirable and indicative of less easily ignited and less flammable material.

### Flame Retardance-UL 94

Burning test were also conducted according to the UL 94 vertical test. UL 94 defines the following categories:

V-0: no afterburning longer than 10 seconds, sum of afterburning times for 10 flame applications not greater than 50 seconds, no flaming droplets, no complete burning of the sample, no after-glowing of the samples longer than seconds after the end of the flame exposure

V-1: no afterburning longer than 30 seconds after the end of the flame, sum of the afterburning times for 10 flame applications not greater than 250 seconds, no afterglow of the samples longer than 60 seconds after the end of the flame, other criteria as for V-0

V-2: Ignition of cotton wool by burning droplets, other criteria as for V-1

Not classifiable (n.k.): does not meet fire class V-2.

In the examples, the afterburning time of 10 flame applications of 5 test specimens is given.

### Smoke Density

Smoke density testing was performed according to ISO 5659 test standard inside an NBS smoke chamber, supplied by Fire Testing Technologies. Test specimens based on TPC1 thermoplastic elastomer were prepared from the compositions of the tables by melt-extruding narrow flat strips in a standard extruder having barrel temperatures set at about 170° C. to about 190° C. and compression moulding the strips to form plaques having an area of 75 mm×75 mm and thickness of 2 mm. Test specimens based on TPC2 thermoplastic elastomer were prepared from the compositions of the tables by melt-extruding pellets in a standard extruder having barrel temperatures set at about 200° C. and injection moulding test specimen in the shape of plaques having an area of 80 mm×80 mm and thickness of 2 mm. The specimens were mounted horizontally within the chamber and exposed to a constant thermal irradiance on their upper surface of 25 kW/m² via a radiator cone and heat flux meter and in the presence of a pilot flame for a period of about 40 min. The smoke evolved over time was collected in the chamber, and the attenuation of a light beam passing through the smoke was measured with a photometric system including a 6.5 V incandescent lamp, a photomultiplier tube, and a high accuracy photodetector. The results were measured in terms of light transmission over time and reported in terms of specific optical density, Dₛ. Dₛ is inversely proportional to light transmission and is given for a specific path length equal to the thickness of the moulded specimen. Comparison between the material compositions is made via the measurement of max specific optical density, D_{s,max}. Any dripping from the plaque test specimen occurring during the test was recorded. A normalised D_{s,max} over the mass retained during the experiment time (in g) was calculated and reported as D_{s, max, ret}.

D_{s,max} values were calculated automatically by the software of the NBS smoke chamber. Low values of D_{s,max,ret} are desirable and indicative of material that will less obscure visibility in the event of fire, thus allowing rapid escape of people from confined spaces. Without any smoke light transmittance is 100% and Dₛ is 0.

### Experimental Data

Compositions designated with “CE” are comparative, and compositions designated with “E” are inventive.

### Table 1

Table 1 shows inventive compositions based on the combination of DEPAl and DEPTi and having optional components metal salts of phosphite and/or melamine pyrophosphate.

All of the inventive compositions have very good flame retardancy performance (LOI≥30) and good smoke performance (D_{s, max, ret}<60). In some instances, for example E4 and E7, poorer smoke performance (i.e. higher value of D_{s, max, ret}) is compensated by a good flammability performance (i.e. high LOI).

### Table 2

Table 2 shows the composition, flammability and smoke performance of polyester (PBT)formulations according to the invention (containing DEPAl and DEPTi) as compared to compositions containing only DEPAl, compositions containing only DEPZn and compositions containing only DEPTi.

### Table 3

Table 3 shows the composition, flammability and smoke performance of polyamide (PA66) formulations according to the invention (containing DEPAl and DEPTi) as compared to compositions containing only DEPAl, compositions containing only DEPZn and compositions containing only DEPTi.

### Table 4

Table 4 shows the composition, flammability and smoke performance of PA 6T/66 formulations according to the invention (containing DEPAl and DEPTi) as compared to compositions containing only DEPAl, compositions containing only DEPZn and compositions containing only DEPTi.

### Table 5

Table 5 shows the composition, flammability and smoke performance of polyamide (PA66) formulations according to the invention (containing DEPAl and DEPTi) as compared to compositions containing only DEPAl, compositions containing only DEPZn and compositions containing only DEPTi.

### Table 6

Table 6 shows the composition, flammability and smoke performance of polyamide (PA66) formulations according to the invention (containing DEPAl and DEPTi) as compared to compositions containing only DEPAl, compositions containing only DEPZn and compositions containing only DEPTi.

TABLE 1

| | CE1 | CE2 | CE3 | CE4 | E1 | E2 | E3 | E4 | CE5 | CE6 | E5 | CE7 |
|---|---|---|---|---|---|---|---|---|---|---|---|---|
| | [%] | [%] | [%] | [%] | [%] | [%] | [%] | [%] | [%] | [%] | [%] | [%] |
| TPC1 | 85 | 85 | 90 | 80 | 80 | 80 | 84 | 80 | 80 | 87.5 | 77.5 | 85 |
| TPC2 | | | | | | | | | | | | |
| DEPAl | 15 | | 10 | 20 | 10 | 10 | 8 | 8 | 15 | 10 | 10 | 10 |
| DEPTi | | 15 | | | 10 | | | | | | | |
| d50 31 μm | | | | | | | | | | | | |
| DEPTi | | | | | | 10 | 8 | 12 | 5 | | 10 | |
| d50 41 μm | | | | | | | | | | | | |
| DEPTi | | | | | | | | | | | | |
| d50 20 μm | | | | | | | | | | | | |
| Al Phosphite | | | | | | | | | | 2.5 | 2.5 | 5 |
| Zn Phosphite | | | | | | | | | | | | |
| Melamine | | | | | | | | | | | | |
| Pyrophosphate | | | | | | | | | | | | |
| Total (%) of all | 100 | 100 | 100 | 100 | 100 | 100 | 100 | 100 | 100 | 100 | 100 | 100 |
| ingredients | | | | | | | | | | | | |
| LOI | 29 | 21 | 21 | 29 | 40 | 38 | 36 | 38 | 36 | 18 | 38 | 24 |
| D_{s, max} | 596 | 529 | 531 | 694 | 538 | 634 | 602 | 654 | 719 | 547 | 465 | 505 |
| D_{s, max, ret} | 50 | 42 | 47 | 56 | 46 | 52 | 50 | 55 | 60 | 45 | 38.8 | 42 |

| | E6 | CE8 | E7 | E8 | E9 | E10 | E11 | E12 | E13 | E14 |
|---|---|---|---|---|---|---|---|---|---|---|
| | [%] | [%] | [%] | [%] | [%] | [%] | [%] | [%] | [%] | [%] |
| TPC1 | 75 | 72 | | | | | 77.5 | 75 | 72 | 72 |
| TPC2 | | | 81.5 | 76.5 | 77.5 | 72.5 | | | | |
| DEPAl | 10 | 10 | 8 | 8 | 8 | 8 | 10 | 10 | 10 | 10 |
| DEPTi | | | | | | | | | | |
| d50 31 μm | | | | | | | | | | |
| DEPTi | 10 | 10 | | | | | 10 | 10 | 10 | 10 |
| d50 41 μm | | | | | | | | | | |
| DEPTi | | | 8 | 8 | 12 | 12 | | | | |
| d50 20 μm | | | | | | | | | | |
| Al Phosphite | 5 | 8 | | | | | | | | 4 |
| Zn Phosphite | | | 2.5 | 2.5 | 2.5 | 2.5 | 2.5 | 5 | 8 | 4 |
| Melamine | | | | 5 | | 5 | | | | |
| Pyrophosphate | | | | | | | | | | |
| Total (%) of all | 100 | 100 | 100 | 100 | 100 | 100 | 100 | 100 | 100 | 100 |
| ingredients | | | | | | | | | | |
| LOI | 35 | 30 | 36 | 32 | 35 | 30 | 39 | 36 | 36 | 37 |
| D_{s, max} | 484 | 619 | 401 | 206 | 456 | 228 | 435 | 447 | 492 | 463 |
| D_{s, max, ret} | 40.7 | 51.2 | 59 | 17 | 38 | 19 | 37 | 37 | 43 | 39 |

TABLE 2
Composition and flammability performance of PBT compositions
according to the invention and comparative examples

| | CE9 | CE10 | CE11 | CE12 | E15 | E16 | E17 |
|---|---|---|---|---|---|---|---|
| PBT (wt %) | 49.4 | 59.4 | 59.4 | 59.4 | 59.4 | 59.4 | 59.4 |
| Glass fibre | 30 | 30 | 30 | 39 | 30 | 30 | 30 |
| (wt %) | | | | | | | |
| DEPAl | 20 | 10 | — | — | 2.5 | 5 | 7.5 |
| (wt %) | | | | | | | |
| DEPZn | — | — | — | 10 | — | — | — |
| (wt %) | | | | | | | |
| DEPTi | — | — | 10 | — | 7.5 | 5 | 2.5 |
| (wt %) | | | | | | | |
| Licowax ® | 0.3 | 0.3 | 0.3 | 0.3 | 0.3 | 0.3 | 0.3 |
| E (wt %) | | | | | | | |
| Irganox ® | 0.3 | 0.3 | 0.3 | 0.3 | 0.3 | 0.3 | 0.3 |
| 1010 | | | | | | | |
| (wt %) | | | | | | | |
| UL94 1.6 | V-0 | V-2 | V-1 | n.k. | V-0 | V-0 | V-0 |
| mm | | | | | | | |
| Afterburn | 35 | 47 | 54 | 180 | 12 | 15 | 33 |
| time (s) | | | | | | | |
| LOI | 36 | 33 | 38 | 27 | 41 | 42 | 39 |
| D_{s, max} | 597 | 548 | 523 | 625 | 435 | 354 | 378 |

TABLE 3
Composition and flammability performance of PA66 compositions
according to the invention and comparative examples

| | CE13 | CE14 | CE15 | E18 | E19 | E20 | E21 | E22 |
|---|---|---|---|---|---|---|---|---|
| PA66 | 57.7 | 49.7 | 54.7 | 54.7 | 54.7 | 54.7 | 54.7 | 54.7 |
| (wt %) | | | | | | | | |
| Glass fibre | 30 | 30 | 30 | 30 | 30 | 30 | 30 | 30 |
| (wt %) | | | | | | | | |
| DEPAl | 12 | 20 | — | 5 | 7.5 | 10 | 5 | 7.5 |
| (wt %) | | | | | | | | |
| DEPTi | — | — | 15 | 10 | 7.5 | 5 | 5 | 2.5 |
| (wt %) | | | | | | | | |
| MPP | — | — | — | — | — | — | 5 | 5 |
| Licowax ® | 0.3 | 0.3 | 0.3 | 0.3 | 0.3 | 0.3 | 0.3 | 0.3 |
| E (wt %) | | | | | | | | |
| UL94 1.6 | n.k. | n.k. | V-1 | V-0 | V-0 | V-1 | V-0 | V-0 |
| mm | | | | | | | | |
| Afterburn | 165 | 123 | 67 | 12 | 15 | 54 | 39 | 32 |
| time (s) | | | | | | | | |

TABLE 4
Composition and flammability performance of PA6T66 compositions
according to the invention and comparative examples

| | CE16 | CE17 | E23 | E24 | E25 | E26 |
|---|---|---|---|---|---|---|
| PA6T66 | 59.7 | 59.7 | 59.4 | 59.7 | 59.7 | 57.7 |
| (wt %) | | | | | | |
| Glass fibre | 30 | 30 | 30 | 30 | 30 | 30 |
| (wt %) | | | | | | |
| DEPAl | 10 | — | 2.5 | 5 | 7.5 | 4 |
| (wt %) | | | | | | |
| DEPTi | — | 10 | 7.5 | 5 | 2.5 | 4 |
| (wt %) | | | | | | |
| Melem | — | — | — | — | — | 4 |
| Licowax ® | 0.3 | 0.3 | 0.3 | 0.3 | 0.3 | 0.3 |
| E (wt %) | | | | | | |
| UL94 1.6 | V-2 | V-1 | V-0 | V-0 | V-0 | V-0 |
| mm | | | | | | |
| Afterburn | 56 | 55 | 23 | 30 | 43 | 23 |
| time (s) | | | | | | |

TABLE 5
Composition and flammability performance of PA66 compositions
according to the invention and comparative examples

| | CE18 | CE19 | CE20 | E27 | E28 | E29 | E30 |
|---|---|---|---|---|---|---|---|
| PA66 | 50 | 50 | 50 | 55 | 55 | 55 | 55 |
| (wt %) | | | | | | | |
| Glass fibre | 30 | 30 | 30 | 30 | 30 | 30 | 30 |
| (wt %) | | | | | | | |
| DEPAl | 13 | 15 | — | 7.5 | 7 | 7 | 5 |
| (wt %) | | | | | | | |
| DEPTi | — | — | 20 | 7.5 | 7 | 7 | 5 |
| (wt %) | | | | | | | |
| Al | — | 5 | — | — | — | 1 | 1 |
| phosphite | | | | | | | |
| Zn | — | — | — | — | 1 | — | — |
| phosphite | | | | | | | |
| MPP | 7 | — | — | — | — | — | 5 |
| UL94 0.8 | V-0 | V-0 | V-0 | V-0 | V-0 | V-0 | V-0 |
| mm | | | | | | | |
| Optical | high | high | high | medium | low | low | low |
| smoke | | | | | | | |
| density | | | | | | | |

TABLE 6
Composition and flammability performance of PA66 compositions
according to the invention and comparative examples

| | CE21 | CE22 | E31 | E32 | E33 | E34 |
|---|---|---|---|---|---|---|
| PA66 | 49.55 | 49.55 | 49.55 | 49.55 | 49.55 | 52.55 |
| (wt %) | | | | | | |
| Glass fibre | 30 | 30 | 30 | 30 | 30 | 30 |
| (wt %) | | | | | | |
| DEPAl | 20 | 15 | 5 | 7 | 5 | 7 |
| (wt %) | | | | | | |
| DEPTi | — | — | 10 | 7 | 5 | 7 |
| (wt %) | | | | | | |
| Zn | — | 2 | 2 | 3 | 2.5 | — |
| phosphite | | | | | | |
| Al | — | — | — | 3 | 2.5 | 3 |
| phosphite | | | | | | |
| MPP | — | 3 | 3 | — | — | — |
| Licowax E | 0.25 | 0.25 | 0.25 | 0.25 | 0.25 | 0.25 |
| UL94 0.8 | V-1 | V-0 | V-1 | V-0 | V-0 | V-0 |
| mm | | | | | | |
| Optical | high | medium | low | low | low | low |
| smoke | | | | | | |
| density | | | | | | |

1. A flame-retardant polymer composition comprising:
(1) at least one polymer selected from polyesters (e.g. copolyetheresters, copolyesteresters), polyamides, polyamide elastomers, thermoplastic polyolefinic elastomers, styrenic elastomers, thermoplastic polyurethanes and thermoplastic vulcanisates;
(2) aluminium diethylphosphinate; and
(3) titanium diethylphosphinate salt.

2. A flame-retardant polymer composition according to claim 1, comprising:
(1) at least one polymer selected from copolyetheresters, copolyesteresters, polyamides, polyamide elastomers, thermoplastic polyolefinic elastomers, styrenic elastomers, thermoplastic polyurethanes, thermoplastic vulcanisates, or a combination thereof;
(2) aluminium diethylphosphinate; and
(3) titanium diethylphosphinate salt; wherein if the d₅₀ of the titanium diethylphosphinate salt (volume %, measured using laser diffraction technology with a Malvern Mastersizer 2000 particle size analyser instrument, in acetone) is greater than 35 microns, the concentration of the aluminium diethylphosphinate is less than or equal to 15 wt %, based on the total weight of the composition.

3. (canceled)

4. The composition of claim 1, wherein the copolyetherester is made by reacting a C₂-C₆ diol with an aromatic diacid moiety and a poly(alkyleneoxide)diol.

5. The composition of claim 1, wherein the copolyetherester is made using a poly(alkyleneoxide)diol selected from poly(ethyleneoxide)diol, poly(propyleneoxide)diol, poly(tetramethyleneoxide)diol (“PTMEG”), and mixtures of these.

6. The composition of claim 1, wherein the copolyetherester is made using a C₂-C₆ diol selected from ethylene glycol, propylene glycol, butylene glycol, and mixtures of these.

7. The composition of claim 1, wherein the copolyetherester is made using an aromatic diacid selected from terephthalate, /so-terephthalate, and mixtures of these.

8. The composition of claim 1, wherein the copolyetherester is made from butylene diol, terephthalate and PTMEG.

9. The composition of claim 1, wherein the concentration of DEPAI (2) plus DEPTi (3) is between 8-30 wt %, based on the total weight of the composition.

10. The composition of claim 1, wherein the concentration of DEPAI is 5 to 25 wt %, based on the total weight of the composition and the concentration of DEPTi is 1 to 15 wt. % based on the total weight of the composition.

11-12. (canceled)

13. The composition of claim 1, wherein the DEPTi has a D₅₀ (volume %, measured using laser diffraction technology with a Malvern Mastersizer 2000 particle size analyser instrument, in acetone) of ≤35 microns.

14. (canceled)

15. The composition of claim 1, which further comprises an aluminium salt of phosphorous acid, a zinc salt of phosphorous acid or both.

16. The composition of claim 1, further comprising aluminium phosphite having the CAS number [CAS 56287-23-1], zinc phosphite having CAS number [CAS 14332-59-3], or a mixture of these.

17-18. (canceled)

19. The composition of claim 1, wherein the total phosphite concentration is from 0.1 to 20 wt %, based on the total weight of the composition.

20. The composition of claim 1, wherein the ratio of DEPAI/DEPTi is less than or equal to 1.

21. (canceled)

22. The composition of claim 1, which further comprises a nitrogen- and/or phosphorus-containing synergist.

23. (canceled)

24. The composition of claim 22, wherein the nitrogen-containing synergist is present at from 2 to 10 wt %, based on the total weight of the composition.

25. (canceled)

26. The composition of claim 1, comprising:
(1) at least one copolyetherester;
(2) DEPAI;
(3) DEPTi;
(4) an aluminium or zinc salt of phosphorous acid, a zinc salt of phosphorous acid or both;
(5) a nitrogen-containing synergist.

27. (canceled)

28. A composition according to claim 26, wherein the nitrogen-containing synergist is melamine pyrophosphate.

29. A composition according to claim 26, wherein the DEPAI is present at 5 to 15 wt %, based on the total weight of the composition and the DEPTi is present at 5 to 15 wt. % based on the total weight of the composition.

30-38. (canceled)

39. A wire or cable comprising a light- or electricity-conducting core surrounded by a sheath made from the composition of claim 1.

40. A shaped article made from the composition according to claim 1.

41. A method for making the composition of claim 1, comprising melt-mixing the ingredients.
